(19) United States
(12) Patent Application Publication
(10) Pub. No.: US 2023/0302587 A1
(43) Pub. Date: Sep. 28, 2023

(54) FIXING DEVICE AND WELDING EQUIPMENT HAVING THE SAME

(71) Applicant: FIH Precision Electronics (Lang Fang) Co., Ltd., Langfang (CN)

(72) Inventors: ZE CHEN, Shenzhen (CN); ZHI-JIN MA, Shenzhen (CN); BING YU, Shenzhen (CN)

(21) Appl. No.: 18/126,333

(22) Filed: Mar. 24, 2023

(30) Foreign Application Priority Data
Mar. 25, 2022 (CN) 202220673744.X

(51) Int. Cl. B23K 37/04

(52) U.S. Cl. CPC B23K 37/0452

(57) ABSTRACT

A fixing device includes a supporting platform configured to support a first workpiece, a receiving member, a plurality of pressing members, and at least one rotating member. The receiving member is positioned on the supporting platform and includes a rotating shaft. An axis of the rotating shaft is parallel to a supporting surface of the supporting platform. Each pressing member includes a first end and a second end. The first end is rotatably connected to the rotating shaft, and the second end can press a second workpiece to the first workpiece. The rotating member is positioned above the receiving member and detachably connected to each pressing member. The at least one rotating member can drive the pressing members to rotate to press or release the second workpiece. The present disclosure reduces the space occupied by the pressing members. The pressing of individual points can be realized.

### FIELD

The subject matter herein generally relates to automatic manufacturing, and more particularly, to a fixing device and a welding equipment having the fixing device.

### BACKGROUND

Electronic devices, such as mobile phones, may have frames and small components mounted on the frames by welding. A fixing device is needed to fix the frame. However, the existing fixing device is large in size, and many multiple pressing points must be pressed at the same time. The fixing device cannot be adapted selectively pressing at individual pressing points, resulting in low efficiency and accuracy. Therefore, there is room for improvement in the art.

### BRIEF DESCRIPTION OF THE DRAWINGS

Implementations of the present technology will now be described, by way of embodiment, with reference to the attached figures.

FIG. 1 is a perspective view of a pressing state of a fixing device according to an embodiment of the present disclosure.

FIG. 2 is a perspective view of a releasing state of the fixing device of FIG. 1.

FIG. 3 is a perspective view showing a first workpiece and a plurality of second workpieces placed on the fixing device according to one embodiment of the present disclosure.

FIG. 4 is one embodiment of an exploded view of a rotating member, a receiving member, and pressing members of the fixing device of FIG. 1.

FIG. 5 is an exploded view of the pressing members of FIG. 4.

FIG. 6 is one embodiment of a perspective view of a welding equipment including a fixing device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and members have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and feat100ures of the present disclosure.

The term “comprising,” when utilized, means “including, but not necessarily limited to”; it specifically indicates open-ended inclusion or membership in the so-described combination, group, series, and the like.

As described in the present disclosure, the terms “parallel to” and “vertical to” are used to describe ideal state between two components. In actual production or use, there may be an approximately parallel or vertical state between the two components. For example, “parallel” may refer to an angle between two straight lines or between two planes in a range of ±10°. “Vertical” may refer to an angle between two straight lines or between two planes in a range of 90±10°.

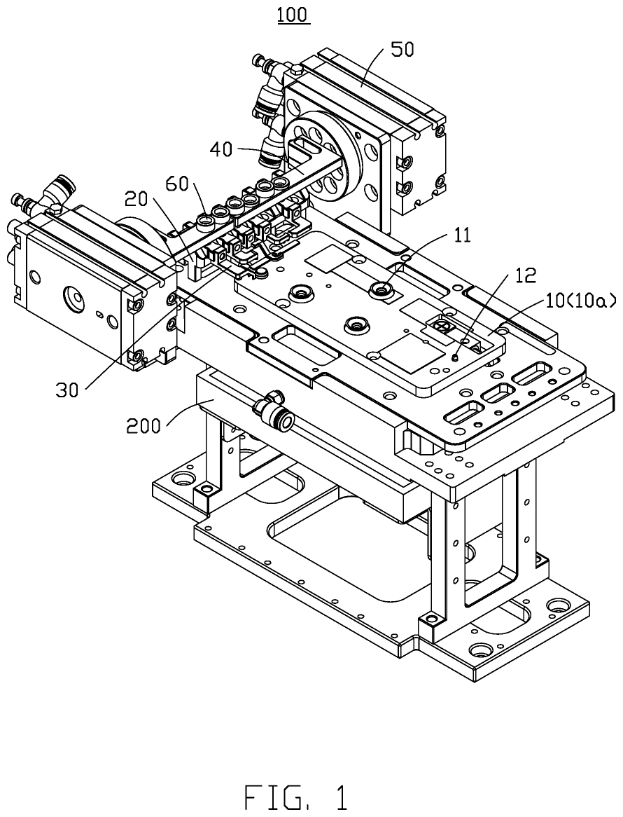

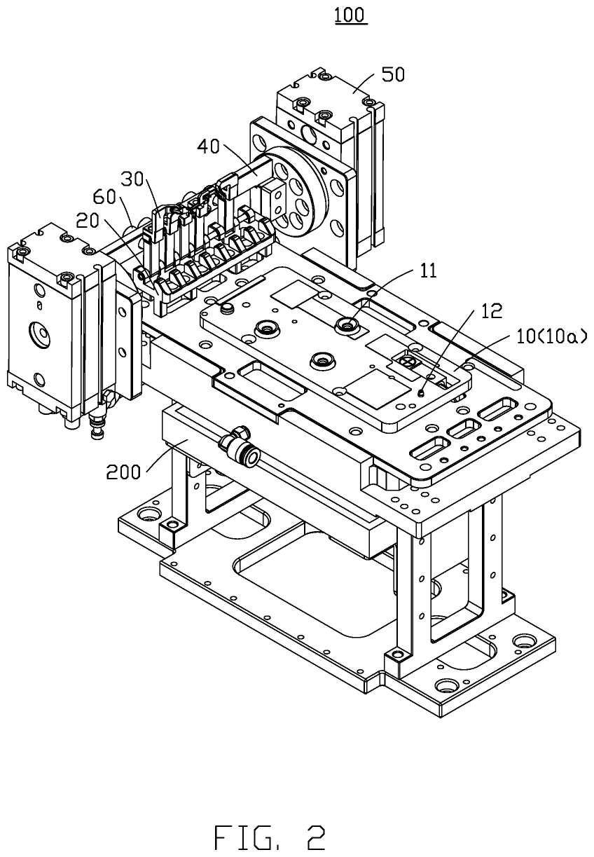

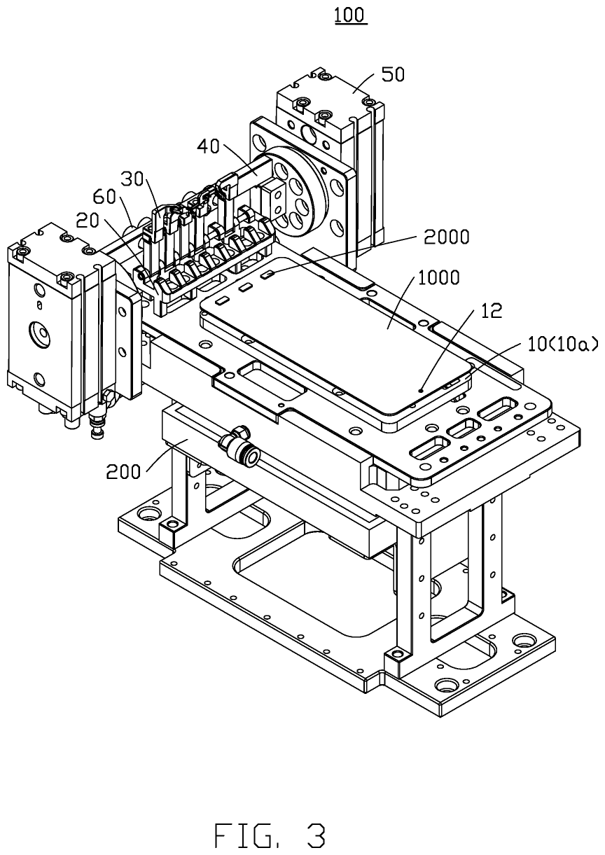

Referring to FIGS. 1 and 2, a fixing device 100 is provided according to an embodiment of the present disclosure. The fixing device 100 is used to press at least one second workpiece 2000 to a first workpiece 1000 (shown in FIG. 3). The fixing device 100 includes a supporting platform 10, a receiving member 20, a plurality of pressing members 30, and at least one rotating member 40.

The supporting platform 10 is arranged horizontally and is positioned at a fixed position of the fixing device 100. The supporting platform 10 is used to support and fix the first workpiece 1000 thereon.

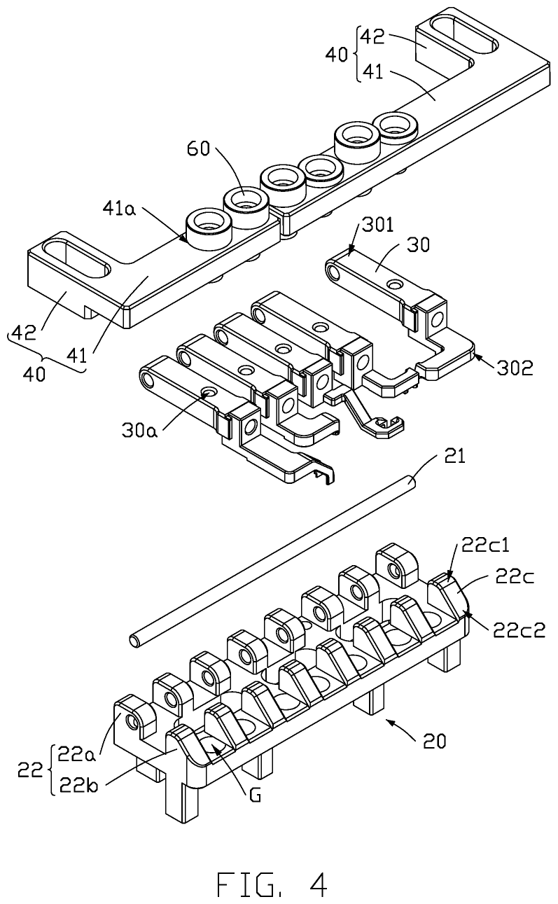

The receiving member 20 is arranged on the supporting platform 10, and placed on one side of the first workpiece 1000. Referring to FIG. 3 and FIG. 4, a rotating shaft 21 is fixed on the receiving member 20. The rotating shaft 21 has a fixed position with respect to the receiving member 20. An axis of the rotating shaft 21 is parallel to a supporting surface 10a of the supporting platform 10. That is, the axis of the rotating shaft 21 is arranged horizontally.

The plurality of pressing members 30 are arranged on the receiving member 20 along the axis of the rotating shaft 21. Each of the plurality of pressing members 30 includes a first end 301 and a second end 302 opposite to the first end 301. The first end 301 of each pressing member 30 is rotatably connected to the rotating shaft 21, causing the second end 302 to rotate around the rotating shaft 21 toward or away from the supporting platform 10. When the second end 302 rotates toward the supporting platform 10, the pressing member 30 can press the second workpiece 2000 to the first workpiece 1000. As such, the position of the second workpiece 2000 is fixed relative to the first workpiece 1000. When the second end 302 rotates away from the supporting platform 10, the second workpiece 2000 can be separated from the first workpiece 1000.

The rotating member 40 is positioned above the receiving member 20. The second end 302 of each pressing member 30 is detachably connected to the rotating member 40. A rotating shaft of the rotating member 40 coincides with the axis of the rotating shaft 21. The rotating member 40 can rotate around its own rotating shaft by preset angles. When the rotating member 40 rotates, the rotating member 40 simultaneously drives the pressing members 30 to rotate around the rotating shaft 21, thereby pressing or releasing the second workpiece 2000. Instead of the existing pressing mode that uses a pressing member to move linearly to press the workpiece, the rotary pressing mode can reduce the space occupied by the pressing members 30.

In at least one embodiment, the first workpiece 1000 may be a frame or a printed circuit board of an electronic device. Each second workpiece 2000 may be an electronic component inside the electronic device. In some occasions, each pressing member 30 corresponds to one electronic component. Different pressing member 30 may have different structures.

Referring to FIG. 4, the receiving member 20 includes a plurality of spacing portions 22 that are spaced apart from each other along the axis of the rotating shaft 21. When the second end 302 rotates toward the supporting platform 10, the pressing member 30 can enter the space defined by each two spacing portions 22. Along the axis of the rotating shaft 21, the width of the space defined by each two spacing portions 22 may be substantially equal to the width of the pressing member 30. Thus, the spacing portions 22 can limit the position of the pressing members 30 to avoid displacement or shaking of the pressing members 30 during rotating process. Even it may affect the pressing effects of the second workpiece 2000. In one embodiment, each of the spaces defined by each two spacing portions 22 may be the same to receive the pressing members 30 with a same width. In other embodiment, each of the spaces defined by each two spacing portions 22 may be different from each other to receive the pressing members 30 with different widths.

In at least one embodiment, each of the spacing portions 22 includes a first protrusion 22a and a second protrusion 22b that is spaced apart from the first protrusion 22a. The direction from the second protrusion 22b to the first protrusion 22a is perpendicular to the axis of the rotating shaft 21. The rotating shaft 21 passes through each of a plurality of first protrusions 22a. The first end 301 of each pressing member 30 is positioned between the two adjacent first protrusions 22a, and is rotatably connected to the rotating shaft 21 (that is, the rotating shaft 21 passes through the first end 301). The second end 302 of each pressing member 30 is positioned between the two adjacent second protrusions 22b. A gap G is formed between each first protrusion 22a and the corresponding second protrusion 22b. Thus, under the condition that the spacing portions 22 can limit the position of the pressing members 30, also can reduce the weight of the spacing portions, and the pressing members 30 are convenient for a user to operate.

In at least one embodiment, the second protrusion 22b includes an inclined surface 22c that is away from the first protrusion 22a. The inclined surface 22c is inclined toward one side of one pressing member 30. The inclined surface 22c includes a first side 22c1 close to the first protrusion 22a and a second side 22c2 opposite to the first side 22c1. A distance between the first side 22c1 and the supporting platform 10 is large than a distance between the second side 22c2 and the supporting platform 10. The inclined surface 22c is used to avoid interference between the second end 302 of the pressing member 30 and the second protrusion 22b that may affect the pressing effects of the second workpiece 2000. In addition, chamfers may be provided on the edges of the second protrusion 22b so that the pressing member 30 may easily enter the gap between each two second protrusions 22a.

In at least one embodiment, the second protrusion 22b is a column, and a top surface of the second protrusion 22b includes a spherical surface (not shown). Thus, the pressing member 30 can efficiently insert into the gap between each two second protrusions 22a, thereby avoiding interference between the pressing member 30 and the second protrusions 22b caused by a slight deviation of the pressing member 30. Thus, the pressing effects of the pressing member 30 can be ensured.

In at least one embodiment, the fixing device 100 includes two rotating members 40 that are positioned on both sides of the receiving member 20 and parallel to the axis of the rotating shaft 21. Each rotating member 40 corresponds to a portion of pressing members 30. The two rotating members 40 can independently rotate to drive the corresponding pressing members 30 to press the second workpiece 2000. For example, in at least one embodiment, one of the rotating members 40 corresponds to two pressing members 30, and the other one of the rotating members 40 corresponds to four pressing members 30. The two rotating members 40 can also synchronously rotate to press the second workpiece 2000.

In at least one embodiment, the fixing device 100 further includes a driver 50. Each rotating member 40 includes a first rod 41 and a second rod 42 perpendicular to the first rod 41. The first rod 41 is positioned above the receiving member 20 and connects to the corresponding pressing members 30. The second rod 42 is connected to the driver 50. A rotating shaft of the driver 50 coincides with the axis of the rotating shaft 21. The driver 50 is used to drive the second rod 42 to rotate around the rotating shaft 21, so as to drive the first rod 41 and the pressing members 30 to rotate. In at least one embodiment, the driver 50 is a pneumatic motor or stepper motor. When in use, the driver 50 can drive the rotating member 40 to rotate 90 degrees to 180 degrees to release the second workpiece 2000.

In at least one embodiment, the first rod 41 defines a plurality of through holes 41a. The through holes 41a are positioned along the axis of the rotating shaft 21. The top surface of each pressing member 30 defines a connecting hole 30a. The positions of the through holes 41a correspond to the positions of the connecting holes 30a. The fixing device 100 further includes a locking member 60 that passes through each through hole 41a and the corresponding connecting hole 30a, thereby connecting the first rod 41 to the pressing member 30. In at least one embodiment, the locking element 60 is a screw bolt. In use, a plurality of pressing members 30 are positioned above the receiving members 20. When one pressing member 30 needs to be separated from the first rod 41 (for example, when a specific type of first workpiece 1000 and a specific type of second piece are needed to be pressed together), all locking members 60 are loosen, and the rotating member 40 is separated from the pressing members 30. Then, the pressing member 30 that is not needed can be pushed backward until the pressing member 30 falls to a free-sag state under the action of gravity. Also, the remaining pressing member 30 can be pushed forward. Then, the rotating member 40 is mounted to the driver 50 again, the pressing member 30 that pushed forward can be fixed to the first rod 41 of the rotating member 40 through the locking members 60. When processing another type of first and second workpieces 1000, 2000, the above steps are repeated to select a desired pressing member 30. Thus, the purpose of the process of different types of workpieces is realized. The pressing members 30 can be replaced or transposed with each other.

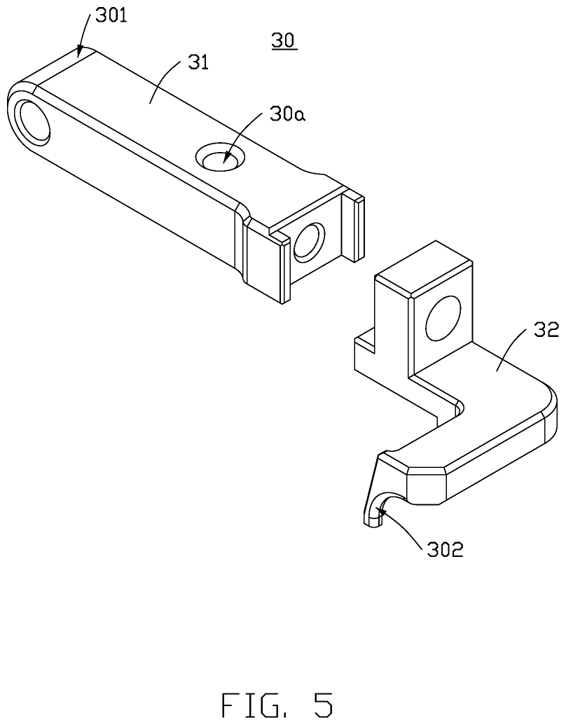

Referring to FIG. 5, in at least one embodiment, to facilitate the replacement, each pressing member 30 includes a main body 31 and a pressing head 32 detachably connected to the main body 31. The structures of different main bodies 31 are the same, while the structures of different pressing heads 32 are different. The second end 302 is provided on the pressing head 32. When in use, any pressing head 32 can be removed when it is for replacement or when it is not needed, without the need to disassemble the locking members 60 and rotating member 40. Thus, the operation efficiency can be improved.

Referring to FIGS. 1 and 2, the supporting surface 10a includes a plurality of suction cups 11 and a positioning pin 12. The positioning pin 12 is used to position the first workpiece 1000. The plurality of suction cups 11 are used to absorb the first workpiece 1000 on the supporting platform 10 to improve stability.

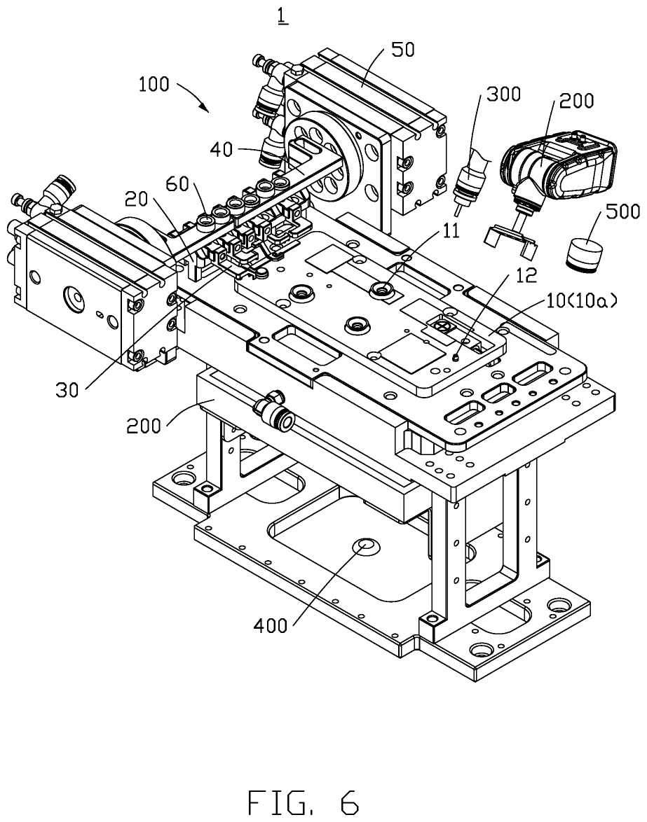

Referring to FIG. 6, a welding equipment 1 is further provided according to an embodiment of the present disclosure. The welding equipment 1 includes an operating member 200, a welding head 300, a backlight 400, a visual inspection head 500, and the fixing device 100. The backlight 200 is positioned below the fixing device 100. After placing the first workpiece 1000 on the supporting platform 10, the backlight 400 is used to illuminate the first workpiece 1000 for the visual inspection head 500. The operating member 200 is used to place the second workpiece 2000 to the first workpiece 1000. After the rotating member 40 drives the pressing members 30 to press the second workpiece 2000, the visual inspection head 500 is further used to detect the welding position of the second workpiece 2000. Then, the welding head 300 is used to weld the second workpiece 2000 to the first workpiece 1000 at the welding position. After welding, the rotating member 40 drives the pressing member 30 to rotate in a reverse direction to release the second workpiece 2000. Finally, the first workpiece 1000 and the second workpiece 2000 that have been welded together are taken away, and another first workpiece 1000 to be welded is placed on the supporting platform 10.

With the above configuration, the rotary pressing mode of the present disclosure, which uses the rotating member 40 to drive the pressing members 30 to rotate to press the second workpiece 2000, can reduce the space occupied by the pressing members 30. Since the pressing members 30 rotates around the rotating shaft 21 and detachably connect to the rotating member 40, when one pressing member 30 is not needed, the pressing member 30 can be rotated toward a side of the supporting platform 10 away from the first workpiece 1000 without any interference with the remaining pressing members 30. Thus, the pressing of individual points can be realized. The operation efficiency and accuracy are also improved.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. A fixing device, comprising:
a supporting platform configured to support a first workpiece;
a receiving member positioned on the supporting platform;
a rotating shaft fixed on the receiving member, an axis of the rotating shaft being parallel to a supporting surface of the supporting platform;
a plurality of pressing members, each of the plurality of pressing members comprising a first end and a second end opposite to the first end, the first end being connected to the rotating shaft, the second end being pressed a second workpiece to the first workpiece; and
at least one rotating member positioned above the receiving member and detachably connected to each of the plurality of pressing members, the at least one rotating member driving the plurality of pressing members to rotate around the rotating shaft and to press or release the second workpiece.

2. The fixing device according to claim 1, wherein the receiving member comprises a plurality of spacing portions disposed along the axis of the rotating shaft, each of the plurality of pressing members is configured to be positioned between each two of the plurality of spacing portions.

3. The fixing device according to claim 2, wherein each of the plurality of spacing portions comprises a first protrusion and a second protrusion spaced apart from the first protrusion, the second protrusion is positioned at one side of the first protrusion and is perpendicular to the axis of the rotating shaft, and the rotating shaft extends through the first protrusion.

4. The fixing device according to claim 3, wherein the second protrusion comprises an inclined surface positioned away from the first protrusion, the inclined surface is inclined toward one side of one of the plurality of pressing members.

5. The fixing device according to claim 1, wherein the fixing device comprises two rotating members, the two rotating members are positioned on both sides of the receiving member and parallel to the axis of the rotating shaft.

6. The fixing device according to claim 5, wherein the two rotating members rotate independently to press the second workpiece.

7. The fixing device according to claim 1, further comprising a driver, wherein each of the at least one rotating member comprises a first rod and a second rod vertically connected to the first rod, the first rod is positioned above the receiving member and connected to the plurality of pressing members, the second rod is connected to the driver, and the driver drives the second rod to rotate around the rotating shaft.

8. The fixing device according to claim 7, wherein the first rod defines a plurality of through holes, a top surface of the plurality of pressing members defines a plurality of connecting holes.

9. The fixing device according to claim 1, wherein the supporting surface of the supporting platform comprises a positioning pin, the positioning pin is used to position the first workpiece.

10. The fixing device according to claim 1, wherein the supporting surface of the supporting platform comprises a plurality of suction cups, the plurality of suction cups are used to absorb the first workpiece on the supporting platform.

11. A welding equipment comprising:
a welding head configured to weld a second workpiece to a first workpiece; and
a fixing device comprising:
a supporting platform configured to support the first workpiece;
a receiving member positioned on the supporting platform;
a rotating shaft fixed on the receiving member, an axis of the rotating shaft being parallel to a supporting surface of the supporting platform;
a plurality of pressing members, each of the plurality of pressing members comprising a first end and a second end opposite to the first end, the first end being connected to the rotating shaft, the second end being pressed a second workpiece to the first workpiece; and
at least one rotating member positioned above the receiving member and detachably connected to each of the plurality of pressing members, the at least one rotating member driving the plurality of pressing members to rotate around the rotating shaft and to press or release the second workpiece.

12. The welding equipment according to claim 1, wherein the receiving member comprises a plurality of spacing portions disposed along the axis of the rotating shaft, each of the plurality of pressing members is configured to be positioned between each two of the plurality of spacing portions.

13. The welding equipment according to claim 12, wherein each of the plurality of spacing portions comprises a first protrusion and a second protrusion spaced apart from the first protrusion, the second protrusion is positioned to one side of the first protrusion and is perpendicular to the axis of the rotating shaft, and the rotating shaft extends through the first protrusion.

14. The welding equipment according to claim 13, wherein the second protrusion comprises an inclined surface positioned away from the first protrusion, the inclined surface is inclined toward one side of one of the plurality of pressing members.

15. The welding equipment according to claim 11, wherein the fixing device comprises two rotating members, the two rotating members are positioned one both sides of the receiving member and parallel to the axis of the rotating shaft.

16. The welding equipment according to claim 15, wherein the two rotating members rotate independently to press the second workpiece.

17. The welding equipment according to claim 11, wherein the fixing device further comprises a driver, each of the at least one rotating member comprises a first rod and a second rod vertically connected to the first rod, the first rod is positioned above the receiving member and connected to the plurality of pressing members, the second rod is connected to the driver, and the driver drives the second rod to rotate around the rotating shaft.

18. The welding equipment according to claim 17, wherein the first rod defines a plurality of through holes, a top surface of the plurality of pressing members defines a plurality of connecting holes.

19. The welding equipment according to claim 11, wherein the supporting surface of the supporting platform comprises a positioning pin, the positioning pin is used to position the first workpiece.

20. The welding equipment according to claim 11, wherein the supporting surface of the supporting platform comprises a plurality of suction cups, the plurality of suction cups are used to adsorb the first workpiece on the supporting platform.
